(19) United States
(12) Patent Application Publication
(10) Pub. No.: US 2025/0321578 A1
(43) Pub. Date: Oct. 16, 2025

(54) PERCEPTION DATA FUSION FOR AUTONOMOUS SYSTEMS AND APPLICATIONS

(71) Applicant: NVIDIA Corporation, Santa Clara, CA (US)

(72) Inventors: Daniel Per Olof Svensson, Gothenburg (SE); Arthur Henry Rajala, Greenville, OH (US); Gyeong Woo Cheon, San Jose, CA (US); Wongun Choi, Los Altos, CA (US); Sangmin Oh, San Jose, CA (US)

(21) Appl. No.: 18/634,123

(22) Filed: Apr. 12, 2024

(51) Int. Cl. G05D 1/24; G05D 1/242; G05D 1/243; G05D 101/15; G05D 111/10; G05D 111/20; G05D 111/30; G06V 10/80; G06V 10/82; G06V 20/58

(52) U.S. Cl. CPC G05D 1/24; G05D 1/242; G05D 1/243; G06V 10/803; G06V 10/82; G06V 20/58; G05D 2101/15; G05D 2111/14; G05D 2111/20; G05D 2111/30

(57) ABSTRACT

Techniques for fusing first information generated using one or more learned models with second information generated using one or more non-learned processes to generate third information including one or more updated versions of the first information and/or the second information. In some examples, the first information may indicate one or more locations associated with one or more first objects in an environment, and the second information may indicate one or more attributes associated with one or more second objects in the environment. In some instances, the learned model(s) may generate the first information based at least on first sensor data generated using one or more first sensors of a machine, and the non-learned process(es) may generate the second information based at least on second sensor data generated using one or more second sensors of the machine.

### BACKGROUND

Machines (e.g., autonomous vehicles or machines, semi-autonomous vehicles or machines, etc.) may use various types of sensor modalities—including, but not limited to, image sensors, RADAR sensors, LiDAR sensors, and ultrasonic sensors—to obtain information associated with their surrounding environments. Since each sensor type may offer unique advantages and/or limitations, combining the strengths of these sensor modalities while mitigating their individual limitations may be crucial for achieving robust obstacle detection in the near range of the machines. Similarly, perception systems of these machines may also employ various processing pipelines—such as learned models, algorithmic processing, probabilistic models, and/or the like—to interpret surrounding environments accurately and make informed decisions to navigate safely.

However, as with different types of sensor modalities, different processing pipelines used by machine perception systems may also have their own sets of advantages and/or disadvantages. For instance, learned models (e.g., machine-learning models) may offer advantages for identifying unclassified objects and estimating object shapes and sizes accurately, which makes learned models particularly valuable in complex environments where objects may have diverse appearances and/or configurations. On the other hand, classical (e.g., non-learned) methods, such as algorithmic processing techniques, may excel in well-understood scenarios and maintain performance in edge cases where training data is limited, making them a more reliable option for ensuring consistent performance.

### SUMMARY

Embodiments of the present disclosure relate to perception data fusion for autonomous and semi-autonomous systems and applications. For instance, systems and methods described herein may fuse first information generated using one or more learned models (e.g., one or more deep neural networks) with second information generated using one or more non-learned processes (e.g., one or more algorithmic processes) to generate third information including one or more updated (e.g., refined, improved, etc.) versions of the first information and/or the second information. That is, the systems and methods may combine the strengths of the learned model(s) and the non-learned process(es) by refining and/or improving the first information based at least on the second information, and/or vice-versa.

In contrast to conventional systems, such as those described above, the current systems, in some embodiments, are able to flexibly combine one or more learned methods and one or more classic sensor processing techniques to robustly detect obstacles in the near range of a machine using a combination of different sensor modalities (e.g., image, RADAR, LiDAR, ultrasonic, etc.). As such, and as described in more detail herein, by performing such processes, the current systems are able to effectively combine the strengths of deep neural networks, such as their ability to identify unclassified objects and accurately estimate object shapes and sizes, with the strengths of classic processing and/or algorithmic methods, including their ability to reliably ensure consistent performance in well-understood scenarios while maintaining acceptable performance in edge cases. This provides improvements over the conventional systems that require the outputs of these disparate techniques to be evaluated independently of each other, which may lead to inaccuracies in object detections and/or ultimately effect a machine's ability to make informed decisions. Additionally, by fusing the information generated by both learned methods and classical methods, the current systems may more accurately perceive the near-field surrounding environment of a machine, including locating objects more precisely and correctly identifying respective attributes of the objects.

### BRIEF DESCRIPTION OF THE DRAWINGS

The present systems and methods for perception data fusion for autonomous and semi-autonomous systems and applications are described in detail below with reference to the attached drawing figures, wherein:

FIG. 1 is a data flow diagram illustrating an example process for fusing disparate information generated using both learned and classic sensor processing techniques, in accordance with some embodiments of the present disclosure;

FIG. 2 is an illustration of an example environment in which one or more machines may operate, in accordance with some embodiments of the present disclosure;

FIG. 3 is an illustration of an example occupancy representation associated with the example environment, which may be generated using one or more learned techniques, in accordance with some embodiments of the present disclosure;

FIG. 4 is an illustration of example object data indicating one or more attributes associated with one or more objects in the example environment, which may be generated using one or more processing techniques, in accordance with some embodiments of the present disclosure;

FIG. 5 is an illustration of an example occupancy history representation associated with the example environment, in accordance with some embodiments of the present disclosure;

FIG. 6 is an illustration including an example updated occupancy representation, in accordance with some embodiments of the present disclosure;

FIG. 7 is a data flow diagram illustrating an example process for training a fusion component, in accordance with some embodiments of the present disclosure;

FIG. 8 is a flow diagram illustrating an example method for fusing information generated using both learned and classic sensor processing techniques, in accordance with some embodiments of the present disclosure;

FIG. 9 is a flow diagram illustrating another example method for fusing information obtained using different processing techniques, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

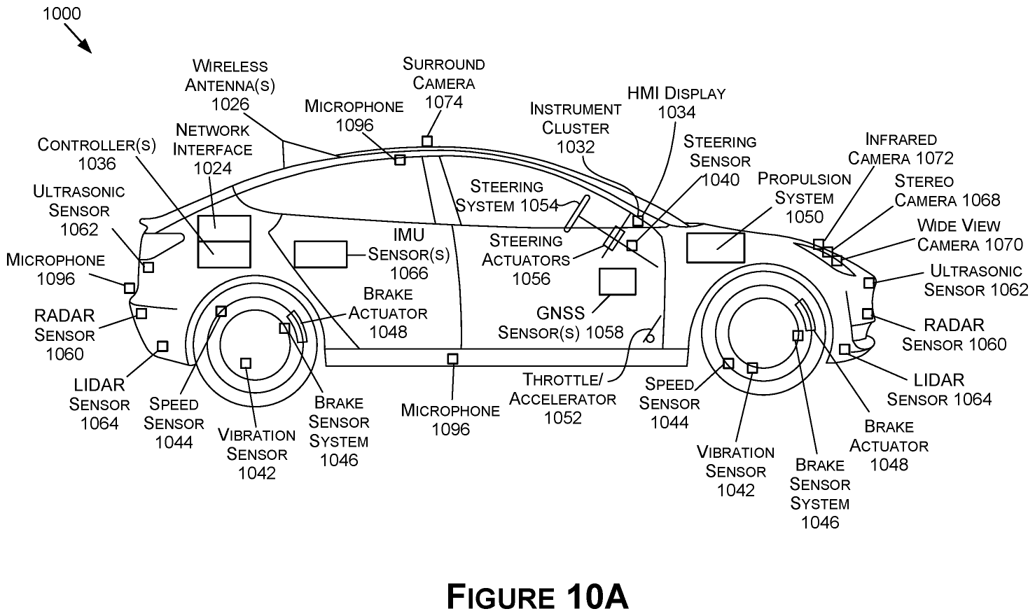

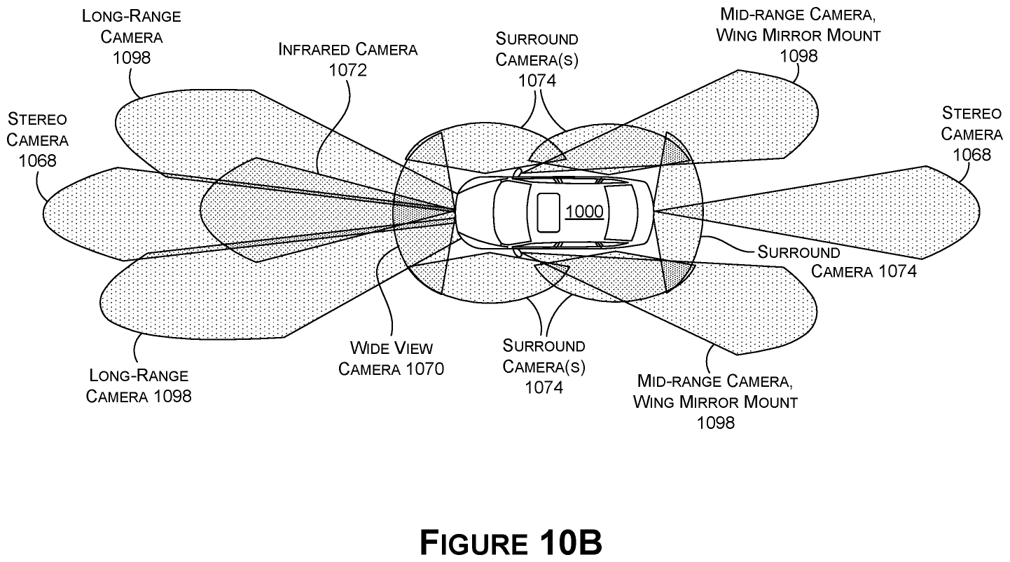

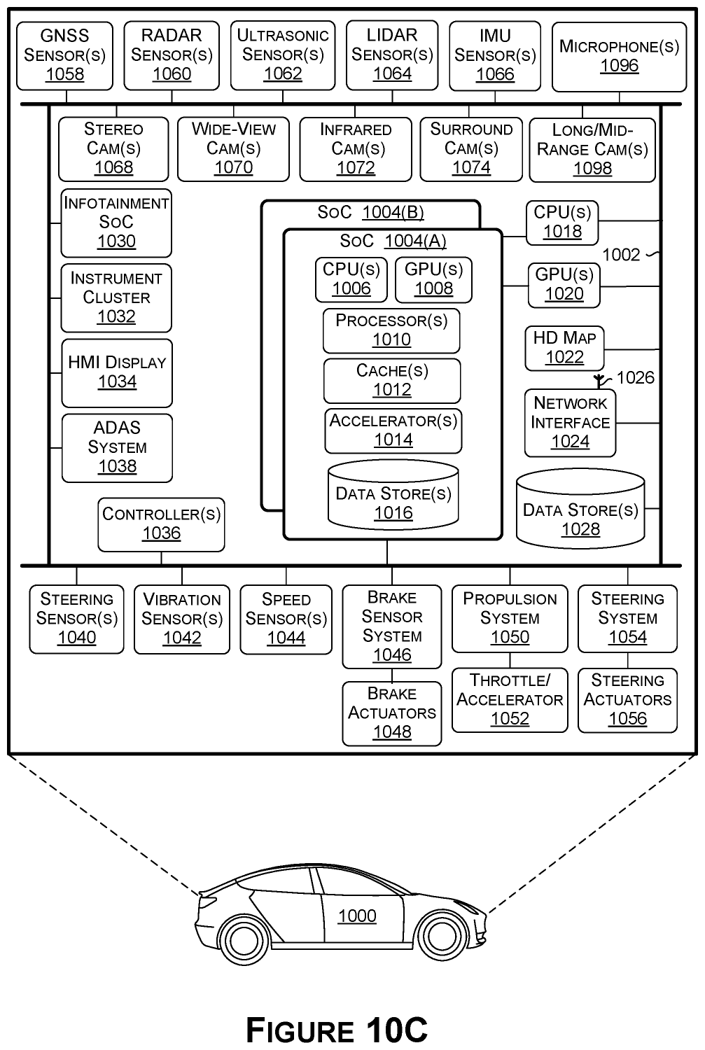

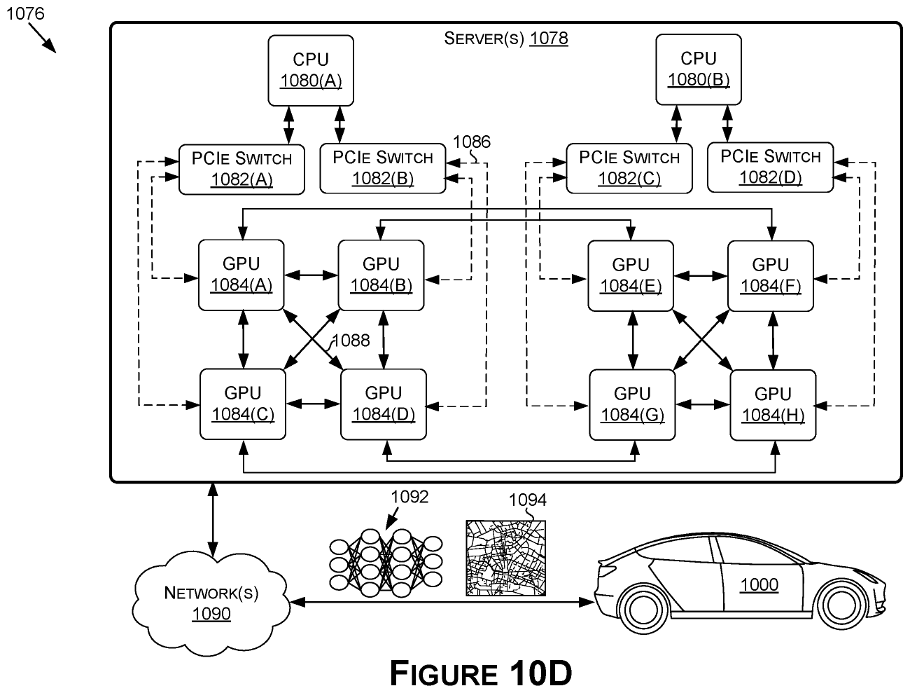

Systems and methods are disclosed related to perception data fusion for autonomous and semi-autonomous systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to perception data fusion in autonomous or semi-autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where object or feature detection and/or map creation may be used.

For instance, a system(s) may generate first data indicating one or more first locations associated with one or more first objects in an environment. In some examples, the system(s) may generate the first data using one or more learned models. The learned model(s) may include, in some instances, a machine-learned model, a deep neural network (DNN), a convolutional neural network (CNN), and/or any other type of model that may be trained to perform object detection, object classification, object tracking, and/or the like. In some examples, the system(s) may generate the first data based at least on first sensor data obtained using one or more first sensors of a machine. The first sensor(s) may, in some examples, include one or more image sensors, one or more RADAR sensors, one or more LiDAR sensors, one or more ultrasonic sensors, and/or the like. As such, the first sensor data may include one or more of image data, RADAR data, LiDAR data, ultrasonic data, and/or the like. In some examples, the first data may be instantaneous (e.g., single-shot, corresponds to a single instance of data or time, etc.) data indicating the first location(s) associated with the first object(s) in the environment surrounding the machine at an instance of time.

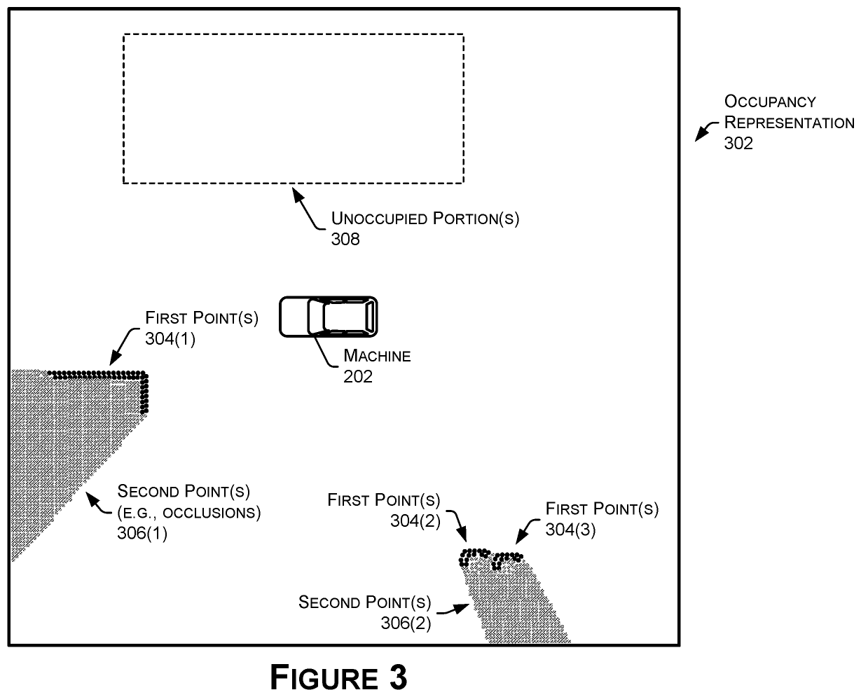

In some examples, the first data may include occupancy data. For instance, the first data may include an occupancy representation (e.g., a dense occupancy map, dense occupancy grid, top-down dense occupancy representation, etc.) associated with the environment from a top-down (e.g., overhead, birds-eye view (BEV), etc.) perspective. The occupancy representation may include one or more points and/or pixels representing one or more samples obtained using the first sensor(s) at the instance of time. That is, the point(s) and/or pixel(s) may indicate various information associated with the environment, and each point/pixel of the occupancy representation may indicate information for that particular location in the environment. For instance, and as will be described in greater detail below with regard to FIG. 3, one or more first points of the occupancy representation may correspond to the first location(s) associated with the first object(s), one or more second points of the occupancy representation may correspond to one or more unoccupied locations in the environment at the instance of time, and one or more third points of the occupancy representation may correspond to one or more occluded portions of the environment at the instance of time. Additionally, in some instances, one or more values of the point(s) may correspond to, or otherwise be indicative of, at least one of a height or a confidence associated with the sample(s). That is, a value (e.g., color, shade, opacity, etc.) of a point or pixel of the occupancy representation may indicate a height of at least a portion of an object at that location and/or a confidence or certainty associated with that point (e.g., whether that point actually corresponds to the portion of the object, a confidence in the height estimation of the portion of the object, etc.). As such, the multiple points or pixels in the occupancy representation and their respective values may collectively indicate shapes of objects, sizes of objects, occupied portions of the environment, unoccupied portions of the environment, occluded portions of the environment, and/or the like.

In some examples, the system(s) may generate second data indicating one or more first attributes associated with one or more second objects in the environment. In some instances, one or more of the second object(s) may be the same as one or more of the first object(s) and/or one or more of the second object(s) may be different from one or more of the first object(s). The system(s) may generate the second data based at least on second sensor data obtained using one or more second sensors of the machine. In some examples, the second data may include a list of objects in the environment. The list of objects may include the first attribute(s) associated with the second object(s). For example, for one or more of the second object(s) included in the list of objects, the first attribute(s) corresponding to those objects may also be listed. In some examples, the attributes that may be included in the list of objects may include one or more of a location of an object (e.g., coordinates), a bounding shape (e.g., a bounding box, a bounding rectangle, a bounding polygon, etc.) of the object, a trajectory of the object (e.g., velocity, acceleration, and/or direction), a pose or orientation of the object, a classification of the object (e.g., vehicle, pedestrian, cyclist, animal, etc.), a shape of the object, a size of the object, whether the object is static or dynamic, and/or the like.

In some examples, the system(s) may generate the second data using one or more classical (e.g., non-learned) methods, such as algorithmic sensor processing, probabilistic processing, thresholding, feature extraction, filtering, and/or the like, which may be single-modality and/or fused. In some examples, the second object(s), the second sensor data, and/or the second sensor(s) may be the same or different from the first object(s), the first sensor data, and/or the first sensor(s) described above. For instance, the second sensor(s) may, in some examples, include the image sensor(s), the RADAR sensor(s), the LiDAR sensor(s), the ultrasonic sensor(s), and/or the like. In some examples, the second data may be temporal data and the first attribute(s) may be tracked or otherwise determined over a period of time that at least partially precedes the instance of time. In this way, the second sensor data may include multiple instances and/or snapshots of sensor data obtained at one or more instances in time throughout the period of time. In some examples, the period of time may precede the instance of time and, in some instances, include the instance of time.

In some examples, the system(s) may generate third data based at least on the first data and/or the second data. As described more here, in some examples, the system(s) may generate the third data by fusing the first data and second data together using one or more learned models, one or more classical (e.g., non-learned) methods, and/or using any other fusion technique. The third data may include or otherwise represent one or more updated versions of the first data and/or the second data. For example, the third data and/or the updated version(s) may include one or more refined and/or improved versions of the first data and/or the second data. In some instances, the system(s) may determine the updated version(s) using at least a portion of the first data and/or the second data. That is, for instance, the system(s) may determine an updated version of the first data based at least on a portion (e.g., some or all) of the second data. Likewise, the system(s) may determine an updated version of the second data based at least on a portion (e.g., some or all) of the first data. In this way, because the system(s) determine the first data using the learned model(s) and determine the second data using the classical method(s), the system(s) may effectively combine the strengths of the learned model(s) and the classical method(s) with the generation of the third data.

To generate the third data, the system(s) may, in some examples, determine one or more of the first object(s) that correspond to one or more of the second object(s). For example, the first data may indicate the first location(s) associated with the first object(s), and the second data may indicate the first attribute(s) associated with the second object(s). As described above and herein, the first attribute(s) may include locations, bounding shapes, trajectories, poses, and/or other information associated with the second object(s). Based at least on the first location(s) of the first data and the various features of the first attribute(s), the system(s) may determine, for instance, the first location(s) associated with the first object(s) that correspond to the various features (locations, bounding shapes, trajectories, poses, etc.) in the first attribute(s). In this way, as well as in other ways, the system(s) may determine that a first object of the first object(s) corresponds to a second object of the second object(s) (e.g., by matching locations, shapes, sizes, poses, etc. between the first data and the second data).

In some examples, the third data may include the updated version of the first data. The updated version of the first data may indicate one or more second locations associated with the first object(s). In some examples, the second location(s) may be more accurate and/or refined than the first location(s) based at least on the first attribute(s) of the second data. That is, in some instances, the system(s) may determine the second location(s) from selective portions of the first data and/or the second data in a way that the second location(s) more accurately/precisely correspond to the actual locations of the first object(s).

In some examples, the updated version of the first data may include an updated version of the occupancy representation. The updated version of the occupancy representation may include one or more second points and/or pixels based at least on the second data. For instance, the updated version of the occupancy representation may be refined and/or improved based on the first attribute(s) included in the second data, and the updated version of the occupancy representation may include the second point(s) and/or pixel(s), which may be changed or added relative to the original version of the occupancy representation in the first data. For example, based on a location of a bounding shape of an object in the second data, one or more points/pixels in the updated version of the occupancy representation may be modified to indicate a more precise location, size, shape, etc. of the object. Additionally, in some examples, the updated version of the first data and/or the occupancy representation may indicate whether the occluded portion(s) of the environment are occupied by at least one of the first object(s) or at least one of the second object(s). In other words, the occupancy representation may be updated to indicate information pertaining to the occluded portion(s) of the environment, which the instantaneous learned model(s) may not have been capable of determining.

In some examples, the third data may additionally, or alternatively, include the updated version of the second data. The updated version of the second data may indicate one or more second attributes associated with the second object(s). In some examples, the second attribute(s) may be more accurate and/or refined than the first attributes(s) based at least on the first location(s) included in the first data. That is, in some instances, the system(s) may determine the second attributes(s) based at least on selective portions of the first data and/or the second data in a way that the second attribute(s) more accurately/precisely correspond to the actual attributes or qualities of the second object(s). For instance, a first bounding shape associated with an object that is included in the first attribute(s) may be updated, in the updated version of the second data, to a smaller or larger size, to a different shape, and/or the like that more closely corresponds with an actual size or shape of the object. Additionally, or alternatively, a first pose/orientation associated with the object from the first attribute(s) may be updated, in the updated version of the second data, to more accurately correspond to an actual pose/orientation of the object. In some instances, the updated version of the first data may include an updated version of the list of objects.

In some examples, as part of determining the third data, the system(s) may generate fourth data indicating one or more prior locations associated with the first object(s) in the environment. The fourth data may represent an occupancy history representation associated with the environment throughout the period of time. For instance, the fourth data may include one or more points (e.g., pixels) representing at least one or more prior samples obtained using the first sensor(s) over a period of time, and refined/improved based at least on the first attribute(s). In some examples, individual points of the point(s) included in the fourth data may be indicative of historical velocity information associated with the first object(s), historical height information associated with the first object(s), historical confidence information associated with the first object(s), and/or the like. In some examples, the system(s) may determine the third data based at least on the fourth data.

In some examples, the system(s) (and/or another system(s)) may train one or more machine learning models to fuse the first data and the second data. That is, the system(s) may train the machine learning models to combine outputs determined using one or more learned methods and one or more classic sensor processing techniques to robustly detect obstacles in the near range of the machine. For instance, and as described in more detail here, the system(s) may train the machine learning model(s) using at least training data generated by different types of processing pipelines (e.g., learned models, classical methods, etc.) and ground truth data representing actual values of parameters associated with objects represented by the training sensor data. Additionally, during the training, the system(s) may generate and input data that is similar to the data that is input into the machine learning model(s) when being used by vehicles or machines.

In some examples, the system(s) may cause the machine to perform one or more operations based at least on the third data. That is, in some instances, the system(s) may cause the machine to perform one or more operations based at least on at least one of the updated version of the first data and/or the updated version of the second data. In some examples, the one or more operations may include providing the third data to a planning component of the machine for updating a trajectory of the machine. Additionally, or alternatively, the system(s) may update a behavior of the machine based at least on the third data, such as causing the machine to operate at lower speeds than normal, causing the machine to increase a distance between itself and other objects in the environment, and/or the like.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more visual language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

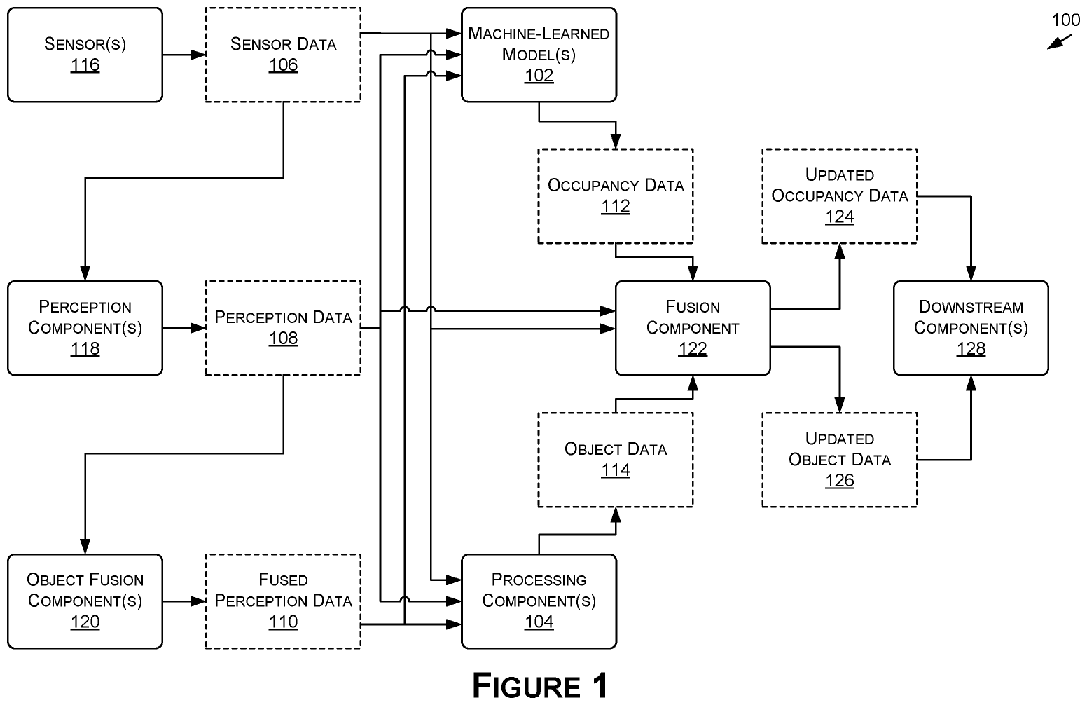

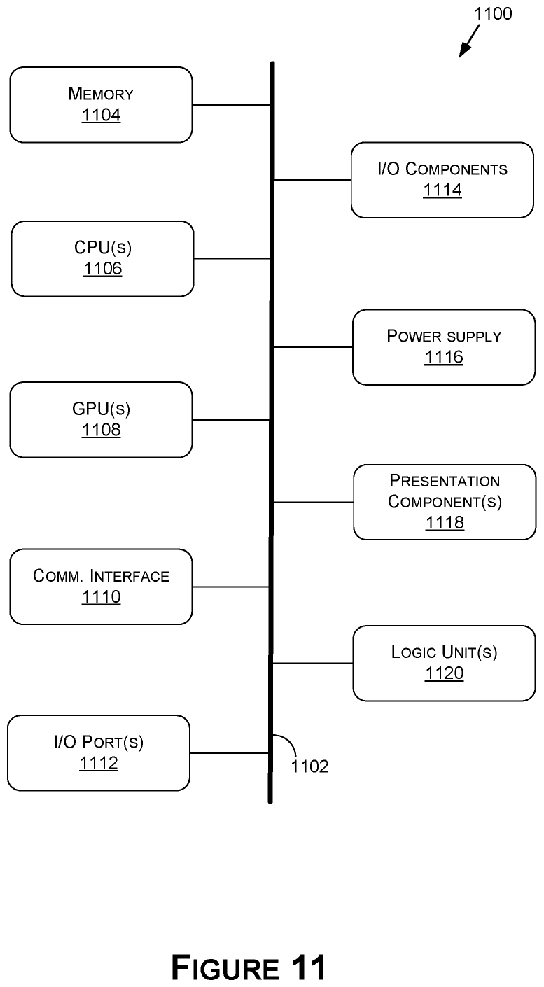

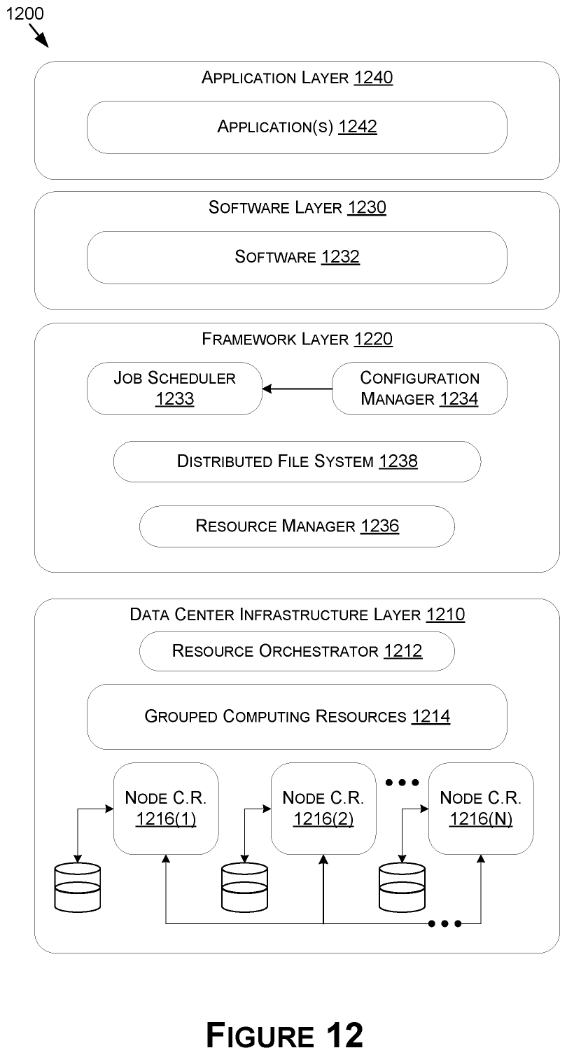

With reference to FIG. 1, FIG. 1 is a data flow diagram illustrating an example process 100 for fusing disparate information generated using both learned and classic sensor processing techniques, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIG. 10A-10D, example computing device 1100 of FIG. 11, and/or example data center 1200 of FIG. 12.

The process 100 includes one or more machine-learned model(s) 102 and one or more processing component(s) 104 that obtain sensor data 106, perception data 108, and/or fused perception data 110. The machine-learned model(s) 102 and the processing component(s) 104 may then generate occupancy data 112 and object data 114, respectively, based at least on one or more of the sensor data 106, the perception data 108, and/or the fused perception data 110.

In examples, the sensor data 106 may be generated using one or more sensor(s) 116 of a machine. The sensor(s) 116 may include, but are not limited to, one or more of image sensors, RADAR sensors, LiDAR sensors, ultrasonic sensors, environmental sensors, and/or any other type of sensors. As such, the sensor data 106 may include, but not be limited to, one or more of image data, RADAR data, LiDAR data, ultrasonic data, environmental data, and/or any other type of sensor data. In some examples, the sensor(s) 116 may include the first sensor(s) and the second sensor(s) described herein. Additionally, the sensor data 106 may include the first sensor data and the second sensor data described herein.

In some examples, one or more perception component(s) 118 may generate the perception data 108 based at least on the sensor data 106. The perception component(s) 118 may include one or more object detectors and/or one or more object trackers for different sensor modalities. For example, the perception component(s) 118 may include a first object detector and/or a first object tracker that detects and/or tracks objects from, for instance, image data, and a second object detector and/or a second object tracker that detects and/or tracks objects from, for instance, RADAR data. In some examples, the perception data 108 may include, in some instances, bounding shapes associated with detected and/or tracked objects in the environment. As such, in some examples, the perception data 108 may include first perception data associated with a first sensor modality (e.g., based on image data), second perception data associated with a second sensor modality (e.g., based on RADAR data), third perception data associated with a third sensor modality (e.g., based on ultrasonic data), and so forth.

In examples, one or more object fusion component(s) 120 may generate the fused perception data 110 that is obtained by the machine-learned model(s) 102 and/or the processing component(s) 104. The object fusion component(s) 120 may generate the fused perception data 110 based at least on the perception data 108. For instance, as describe above and herein, the perception data 108 may include one or more instances of perception data for different sensor modalities, and the object fusion component(s) 120 may fuse the different instances of the perception data together as the fused perception data 110. That is, the object fusion component(s) 120 may, in some examples, improve the perception data 108 by selectively incorporating the strengths of each different sensor modality into a single instance of the fused perception data 110.

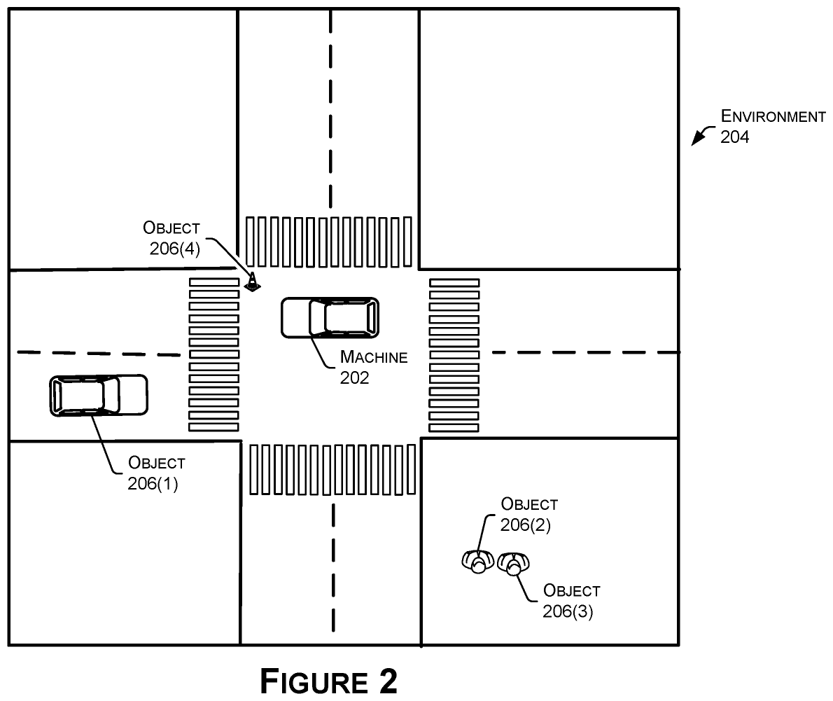

In examples, the sensor data 106, the perception data 108, and/or the fused perception data 110 may represent a number of objects in an environment. For instance, FIG. 2 is an illustration of an example environment 204 in which one or more machines may operate, such as the machine 202 (e.g., a vehicle), in accordance with some embodiments of the present disclosure. In the example of FIG. 2, while navigating around the environment 204, the machine 202 may use sensors (e.g., the sensor(s) 116, etc.) to generate sensor data (e.g., the sensor data 106, etc.) representing a number of objects 206(1)-206(4) (also referred to singularly as “object 206” or in plural as “objects 206”) near the machine 202 in the environment 204. Additionally, the machine 202 may use one or more components (e.g., the perception component(s) 118, the object fusion component(s) 120, etc.) to process the sensor data (e.g., the sensor data 106, etc.) and generate perception information (e.g., the perception data 108, the fused perception data 110, etc.) associated with the objects 206. While the example of FIG. 2 illustrates the object 206(1) as including another machine, the objects 206(2)-206(3) as including pedestrians, and the object 206(4) is including a traffic cone, in other examples, the objects 206 may include any other type of object (e.g., cyclists, structures, street signs, animals, vegetation, etc.). Additionally, while the example of FIG. 2 describes the sensor data as representing four objects 206, in other examples, the machine 202 may generate sensor data representing any number of objects (e.g., one object, ten objects, fifty objects, one hundred objects, one thousand objects, etc.). Further, although described as detecting, tracking, or determining parameters for objects, objects is to extend to static objects, dynamic objects, undulations/perturbations in a surface (such as a driving surface), cavities or holes in a surface, and/or features (road markings, etc.) within the environment.

Referring back to the example of FIG. 1, the process 100 may include the machine-learned model(s) 102 generating occupancy data 112 based at least on one or more of the sensor data 106, the perception data 108, and/or the fused perception data 110. In some examples, the machine-learned model(s) 102 may include one or more deep neural networks (DNN) for processing the sensor data 106, the perception data 108, and/or the fused perception data 110 in order to generate the occupancy data 112. In some examples, the occupancy data 112 may correspond to the first data described above that indicates the first location(s) associated with the first object(s) in the environment. In some examples, the occupancy data 112 may be instantaneous (e.g., single-shot, correspond to a single data instance and/or single time instance, etc.) data indicating the first location(s) associated with the first object(s) in the environment surrounding the machine—e.g., at an instance of time.

In some examples, the occupancy data 112 may include an occupancy representation (e.g., a dense occupancy map, dense occupancy grid, etc.) associated with the environment. For instance, FIG. 3 is an illustration of an example occupancy representation 302 associated with the example environment 204, which may be generated using one or more learned techniques (e.g., the machine-learned model(s) 102), in accordance with some embodiments of the present disclosure. In some examples, the occupancy representation 302 may be associated with a top-down (e.g., overhead, birds-eye, etc.) perspective. The occupancy representation 302 may include one or more points and/or pixels representing one or more samples obtained using the sensor(s) 116 at the instance of time. That is, the point(s) and/or pixel(s) may indicate various information associated with the environment, and each point/pixel of the occupancy representation 302 may indicate information for that particular location in the environment. For instance, one or more first points 304(1)-304(3) (also referred to singularly as “first point 304” or in plural as “first points 304”) of the occupancy representation 302 may correspond to the object(s) 206(1)-206(3), respectively. Additionally, one or more second points 306(1)-306(2) (also referred to singularly as “second point 306” or in plural as “second points 306”) of the occupancy representation 302 may correspond to one or more occluded portions of the environment at the instance of time. Further, one or more third points of the occupancy representation 302 may correspond to one or more unoccupied portions of the environment at the instance of time, which may be represented by blank space in FIG. 3, such as the one or more unoccupied portion(s) 308. In other words, for ease of illustration and understanding, the third point(s) are not included in the occupancy representation 302, however, the blank (e.g., white) space within the occupancy representation 302 may include the one or more third point(s) that may have a different appearance (e.g., shade, color, etc.) than the first point(s) 304 and/or the second point(s) 306.

With reference still to FIG. 3, in some instances, one or more values of the point(s) may correspond to, or otherwise be indicative of, at least one of a height or a confidence associated with the sample(s). That is, a value (e.g., color, shade, opacity, etc.) of one of the first points 304 and/or second points 306 in the occupancy representation 302 may indicate a height of at least a portion of an object at that location and/or a confidence or certainty associated with that point (e.g., whether that point actually corresponds to the portion of the object, a confidence in the height estimation of the portion of the object, etc.). For example, the first point(s) 304(1) corresponding to the object 206(1) may be represented using one or more first colors indicating different height measurements associated with the object 206(1) at those respective points/locations. Additionally, the first point(s) 304(2) corresponding to the object 206(2) may be represented using one or more second colors indicating different height measurements associated with the object 206(2) at those respective points/locations.

Referring back to the example of FIG. 1, the process 100 may include the processing component(s) 104 using one or more algorithmic sensor processing and/or other classical (e.g., non-learned) methods to process the sensor data 106, the perception data 108, and/or the fused perception data 110 in order to generate object data 114. In some examples, the object data 114 may indicate one or more attributes corresponding with one or more objects represented in the sensor data 106, the perception data 108, and/or the fused perception data 110. In some examples, the object data 114 may include a list the object(s) and/or their respective attributes. Such attributes associated with an object may include, but are not limited to, a location of the object, a bounding shape associated with the object, a trajectory of the object, a pose/orientation associated with the object, and/or a classification of the object. In contrast to the occupancy data 112, which may be instantaneous or correspond to a single time or data instance, the object data 114 may be temporal and tracked over a period of time. However, in some embodiments, the occupancy data may also include a temporal element such that smoothing may be applied to the results over time, such as by combining multiple current and past outputs using, for example, a weighting scheme that favors more recent data instances.

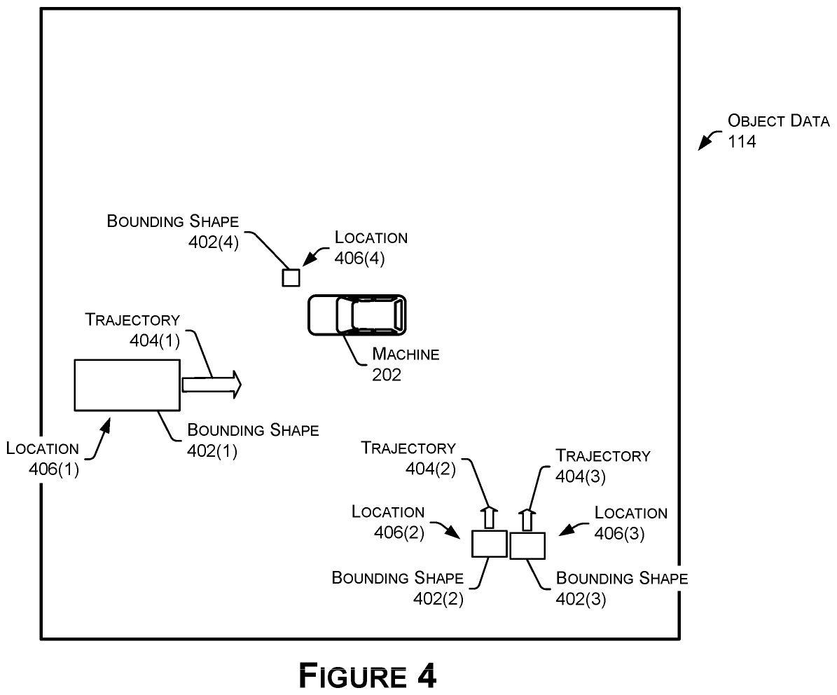

In some examples, the object data 114 indicative of the attribute(s) associated with the object(s) may be represented visually and/or as a list. As an example of the object data 114 being presented visually, FIG. 4 is an illustration of example object data 114 indicating attribute(s) associated with the objects 206 in the example environment 204, which may be generated using one or more processing techniques (e.g., algorithmic processing) employed by the processing component(s) 104, in accordance with some embodiments of the present disclosure. In the example of FIG. 4, the illustrated attributes may correspond to the objects 206(1)-206(4) of FIG. 2. The object data 114 may include or otherwise indicated one or more bounding shapes 402(1)-402(4) (also referred to singularly as “bounding shape 402” or in plural as “bounding shapes 402”), one or more trajectories 404(1)-404(3) (also referred to singularly as “trajectory 404” or in plural as “trajectories 404”), and/or one or more locations 406(1)-406(4) (also referred to singularly as “location 406” or in plural as “locations 406”). The bounding shape 402(1), the trajectory 404(1), and the location 406(1) may correspond to the object 206(1). Similarly, the bounding shapes 402(2) and 402(3), the trajectories 404(2) and 404(3), and the locations 406(2) and 406(3) may correspond to the objects 206(2) and 206(3), respectively. And the bounding shape 402(4) and the location 406(4) may correspond to the object 206(4). In some examples, the object data 114 may further indicate a classification of the objects 206, such as by a color, shade, shape, etc. of the bounding shape 402(1), with a label indicating the classification, and/or the like.

Additionally, or alternatively, the object data 114 may be represented non-visually as a list of objects. For example, the list may include one or more identifiers corresponding to the objects 206, and each identifier for each object may be associated with one or more listed attributes. For an object identifier in the list of objects, the listed attributes may include, but are not limited to, a location of the object (e.g., coordinates), a bounding shape of the object (e.g., coordinates or another measurement indicating a size or perimeter of the bounding shape), a trajectory of the object (e.g., velocity, acceleration, and/or direction), a pose or orientation of the object (e.g., a heading of the object in degrees), a classification of the object (e.g., vehicle, pedestrian, cyclist, animal, etc.), an indication of whether the object is static or dynamic, and/or the like.

Referring back to the example process 100 illustrated in FIG. 1, the fusion component 122 may obtain the occupancy data 112 from the machine-learned model(s) 102, as well the object data 114 from the processing component(s) 104, and generate updated occupancy data 124 and/or updated object data 126. In some examples, the fusion component 122 may generate the updated occupancy data 124 based at least on the occupancy data 112 and at least a portion of the object data 114. Similarly, the fusion component 122 may generate the updated object data 126 based at least on the object data 114 and at least a portion of the occupancy data 112. Additionally, in some examples, the fusion component 122 may obtain the sensor data 106 and/or the perception data 108 directly from the sensor(s) 116 and/or the perception component(s) 118, and determine the updated occupancy data 124 and/or the updated object data 126 based at least on a portion of this data as well. In examples, the updated occupancy data 124 may represent a refined and/or improved version of the occupancy data 112. Likewise, the updated object data 126 may represent a refined and/or improved version of the object data 114.

As noted above, in some instances, the fusion component 122 may determine the updated occupancy data 124 using at least a portion of the object data 114. That is, for instance, the fusion component 122 may determine the updated occupancy data 124 based at least on a portion (e.g., some or all) of the object data 114. For example, the fusion component 122 may use one or more bounding shapes from the object data 114 to refine the points included in the occupancy data 112 and/or reduce occluded regions. Likewise, the fusion component 122 may determine the updated object data 126 using at least on a portion of the occupancy data 112. For example, the fusion component 122 may use one or more points included in the occupancy data 112 to refine one or more bounding shapes, poses, classifications, etc. in the object data 114. In this way, the fusion component 122 may effectively combine the strengths of the machine-learned model(s) 102 and the processing component(s) 104, while reducing and/or minimizing their weaknesses, to generate one or more improved data structures that may convey robust information associated with a surrounding environment so that a machine can make safer and/or more informed decisions.

To generate the updated occupancy data 124 and/or the updated object data 126, the fusion component 122 may, in some examples, determine one or more corresponding objects between the occupancy data 112 and the object data 114. For example, the fusion component 122 may identify a first object in the occupancy data 112 that corresponds to a second object in the object data 114, identify a third object in the occupancy data 112 that corresponds to a fourth object in the object data 114, and so forth. For instance, and with reference to FIGS. 2-4, the occupancy representation 302 of the occupancy data 112 may include the first point(s) 304(1) indicating locations associated with the object 206(1), and the object data 114 may indicate the bounding shape 402(1) and/or the location 406(1) as attribute(s) associated with the object 206(1), as well as potentially other useful information for the fusion process not shown. In some examples, the fusion component 122 may process the occupancy data 112 and the object data 114 to determine an alignment between the features included in the occupancy data 112 (e.g., the occupancy representation 302) and the object data 114. The fusion component 122 may then determine, based at least on the processing, that the first point(s) 304(1), the bounding shape 402(1), and/or the location 406(1) all correspond to the object 206(1). Based on this correspondence, the fusion component 122 may associate the features with the object 206(1). In examples, the fusion component 122 may repeat this process one or more times to determine which features/objects in the occupancy data correspond to the features/objects in the object data 114, and/or vice-versa.

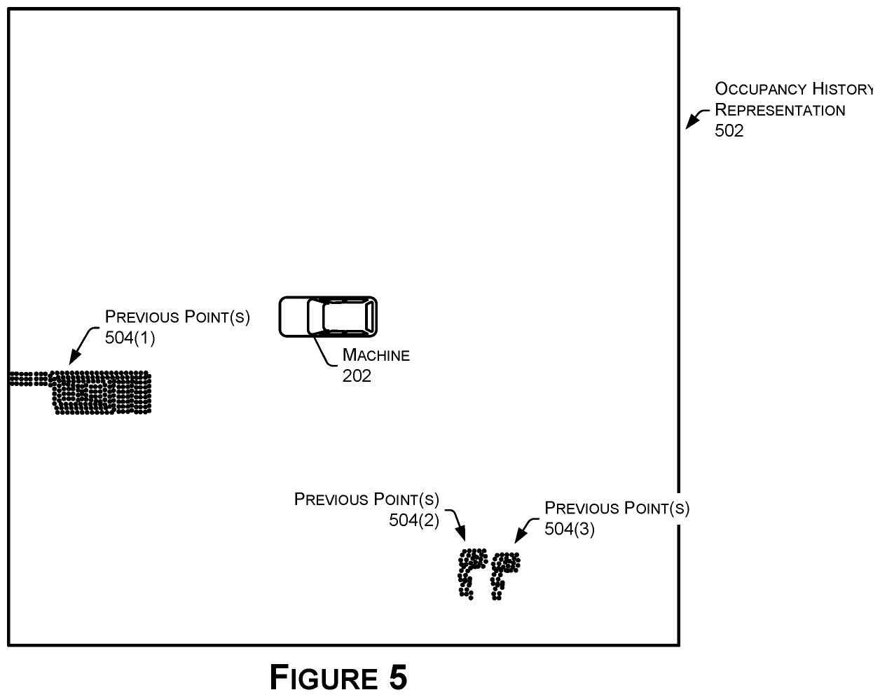

Additionally, in some examples, as part of generating the updated occupancy data 124 and/or the updated object data 126, the fusion component 122 may generate occupancy history data indicating one or more prior locations associated with the object(s) in the environment. For instance, FIG. 5 is an illustration of an example occupancy history representation 502 associated with the example environment 204, in accordance with some embodiments of the present disclosure. The occupancy history representation 502 may indicate various locations of one or more previous points 504(1)-504(3) (which may also be referred to singularly or collectively as the “previous point(s) 504”) corresponding to the objects 206 in the environment 204 throughout the period of time. For instance, the previous point(s) 504(1) may correspond to the object 206(1), the previous point(s) 504(2) may correspond to the object 206(2), and the previous point(s) 504(3) may correspond to the object 206(3). In some examples, the previous point(s) 504 may be determined from previous instances of the updated occupancy data 124 and/or the updated object data 126. Additionally, or alternatively, the previous point(s) 504 may represent one or more prior samples obtained using the sensor(s) 116 over the period of time, and refined/improved based at least on the object data 114. In some examples, the previous point(s) 504 may be indicative of historical velocity information associated with the objects 206, historical height information associated with the objects 206, historical confidence information, and/or the like.

Referring back to the example of FIG. 1, the updated occupancy data 124 may include one or more additional points and/or pixels, relative to the occupancy data 112, based at least on the object data 114. Additionally, or alternatively, the updated occupancy data 124 may include one or more improved, changed, and/or refined points and/or pixels relative to the occupancy data 112. That is, one or more values of the original points included in the occupancy representation 302 may be changed from a first value to a second value based at least on the object data 114. For example, based on a location of a bounding shape of an object in the object data 114, one or more points/pixels in the updated occupancy data/representation may be modified to indicate a more precise location, size, shape, etc. of the object.

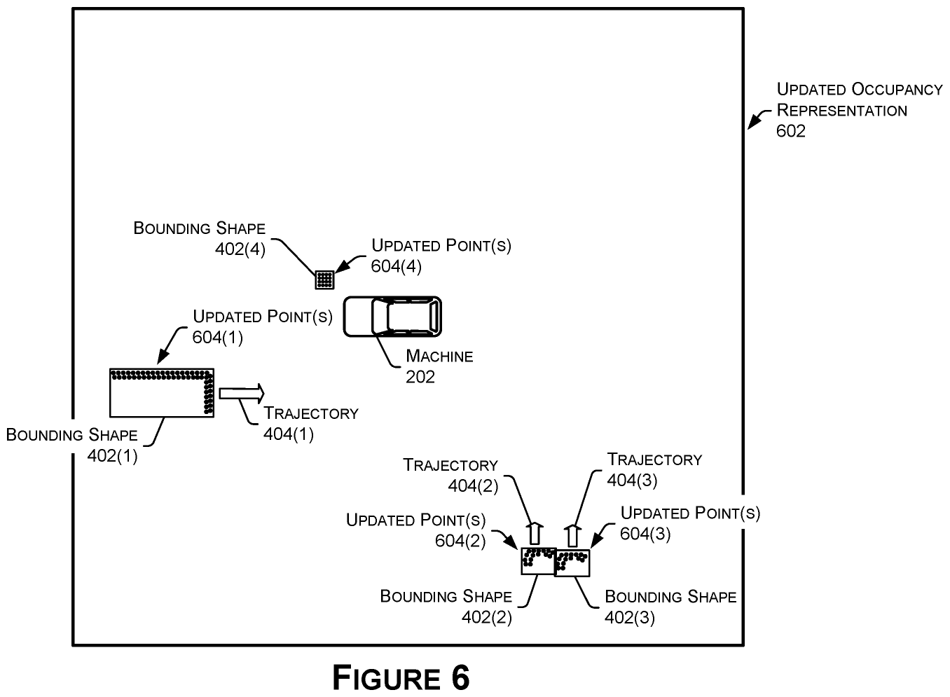

For example, FIG. 6 is an illustration including an example updated occupancy representation 602, in accordance with some embodiments of the present disclosure. In some examples, the updated occupancy representation 602, which may be included in the updated occupancy data 124, may include one or more updated point(s) 604(1)-604(4) corresponding to the objects 206 in the environment 204. Additionally, in some examples, the updated occupancy representation 602 may include the bounding shapes 402(1)-402(4) associated with the objects 206, as well as the trajectories 404(1)-404(3). In some examples, these features from the object data 114 may be overlayed on the updated occupancy representation 602. In some examples, because the features from the object data 114 are temporal and tracked over time, the features (e.g., the bounding shapes 402, the trajectories 404, and other features) may help the fusion component 122 to smooth out the updated point(s) 604 and generate a realistic representation.

Additionally, the updated occupancy representation 602 may include one or more features not included in the original occupancy representation 302. For instance, the machine-learned model(s) 102 may inadvertently miss detecting various objects in the environment, such as the object 206(4) including the traffic cone. As such, the occupancy data 112 and/or the occupancy representation 302 may omit one or more points corresponding to these features. However, because the fusion component 122 is able to extract various features from the sensor data 106, the perception data 108, and/or the object data 114, such as the bounding shape 402(4) corresponding to the object 206(4), the fusion component 122 may update the occupancy representation with one or more of these features. Additionally, in some instances, the fusion component 122 may update the updated occupancy representation 602 to include the updated point(s) 604(4) corresponding to the object 206(4). In some examples, the updated point(s) 604(4) may be included in the sensor data 106 and/or the perception data 108.

Still with reference to FIG. 6, in some examples, the updated occupancy representation 602 may update the occluded portion(s) (e.g., those indicated by the second point(s) 306 of the original occupancy representation 302) of the environment to indicate more information about those regions. For instance, the fusion component 122 may generate the updated occupancy representation 602 to indicate whether or not the occluded portions are occupied by one or more objects. As an example, if the object data 114 indicates a bounding box in one of the occluded portions, or if the sensor data 106 and/or the perception data 108 indicate one or more such features, then the updated occupancy representation 602 may indicate the presence and/or location of such objects/features.

Referring back now to the example of FIG. 1, the updated object data 126 may, in some examples, indicate one or more updated (e.g., refined, improved, etc.) attributes associated with the objects 206. In some examples, the updated object data 126 may include an updated list of objects. In some instances, such an updated list of objects may include more or less objects and/or attributes than included in the object data 114 (e.g., more objects if the occupancy data 112 indicated additional objects, more attributes if the occupancy data 112 provided information indicate of previously unknown attributes, etc.). Additionally, or alternatively, the updated list of objects in the updated object data 126 may include one or more updated attributes associated with the object(s) (e.g., an updated bounding shape that more accurately represents the object, an updated trajectory based on a newly detected pose of the object from the occupancy data 112, etc.). In some examples, the attribute(s) of the updated object data 126 may be more accurate and/or refined than the attributes(s) of the object data 114 based at least on the information included in the occupancy data 112.

In some examples, the process 100 includes one or more downstream component(s) 128 that obtain one or more of the updated occupancy data 124 and/or the updated object data 126. In some examples, the downstream component(s) 128 may include one or more systems of the machine, such as a tracking system that is configured to create, update, and/or terminate tracks associated with objects surrounding the vehicle. While these are just a couple examples of what the additional downstream component(s) 128 may include, in other examples, the other downstream component(s) 128 may include any other type of component, system, algorithm, and/or the like that utilizes the updated occupancy data 124 and/or the updated object data 126 to perform an operation, a task, and action, and/or the like.

For instance, the updated occupancy data 124 and/or the updated object data 126 may be used by an autonomous or semi-autonomous driving software stack (which may be represented by the downstream component(s) 128) to perform one or more operations by the machine (and/or other ego-vehicle type). For example, the drive stack may include a world model manager that may be used to generate, update, and/or define a world model. The world model manager may use information generated by and received from the perception component(s) of the drive stack. The perception component(s) may include an obstacle perceiver, a path perceiver, a wait perceiver, a map perceiver, and/or other perception component(s). For example, the world model may be defined, at least in part, based on affordances for obstacles, paths, and wait conditions that can be perceived in real-time or near real-time by the obstacle perceiver, the path perceiver, the wait perceiver, and/or the map perceiver. The world model manager may continually update the world model based on newly generated and/or received inputs (e.g., data) from the obstacle perceiver, the path perceiver, the wait perceiver, the map perceiver, and/or other components of the vehicle. For example, the world model manager and/or the perception components may use the updated occupancy data 124 and/or the updated object data 126 to perform one or more operations.

The world model may be used to help inform planning component(s), control component(s), obstacle avoidance component(s), and/or actuation component(s) of the drive stack. The obstacle perceiver may perform obstacle perception that may be based on where the vehicle is allowed to drive or is capable of driving, and how fast the vehicle can drive without colliding with an obstacle (e.g., an object, such as a structure, entity, vehicle, etc.) that is sensed by the vehicle (and represented in the updated occupancy data 124 and/or the updated object data 126, for example).

The path perceiver may perform path perception, such as by perceiving nominal paths that are available in a particular situation. In some examples, the path perceiver may further take into account lane changes for path perception. A lane graph may represent the path or paths available to the vehicle, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information.

The wait perceiver may be responsible to determining constraints on the vehicle as a result of rules, conventions, and/or practical considerations. For example, the rules, conventions, and/or practical considerations may be in relation to traffic lights, multi-way stops, yields, merges, toll booths, gates, police or other emergency personnel, road workers, stopped busses or other vehicles, one-way bridge arbitrations, ferry entrances, etc. In some examples, the wait perceiver may be responsible for determining longitudinal constraints on the vehicle that require the vehicle to wait or slow down until some condition is true. In some examples, wait conditions arise from potential obstacles, such as crossing traffic in an intersection, that may not be perceivable by direct sensing by the obstacle perceiver, for example (e.g., by using sensor data from the sensors, because the obstacles may be occluded from field of views of the sensors). As a result, the wait perceiver may provide situational awareness by resolving the danger of obstacles that are not always immediately perceivable through rules and conventions that can be perceived and/or learned. Thus, the wait perceiver may be leveraged to identify potential obstacles and implement one or more controls (e.g., slowing down, coming to a stop, etc.) that may not have been possible relying solely on the obstacle perceiver.

The map perceiver may include a mechanism by which behaviors are discerned, and in some examples, to determine specific examples of what conventions are applied at a particular locale.

The planning component(s) may include a route planner, a lane planner, a behavior planner, and a behavior selector, among other components, features, and/or functionality. The route planner may use the information from the map perceiver, the map manager, and/or the localization manger, among other information, to generate a planned path that may consist of GNSS waypoints (e.g., GPS waypoints). The waypoints may be representative of a specific distance into the future for the vehicle, such as a number of city blocks, a number of kilometers/miles, a number of meters/feet, etc., that may be used as a target for the lane planner.

The lane planner may use the lane graph (e.g., the lane graph from the path perceiver, which may be generated using, at least in part, the updated occupancy data 124 and/or the updated object data 126), object poses within the lane graph (e.g., according to the localization manager), and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The behavior planner may determine the feasibility of basic behaviors of the vehicle, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) may follow a trajectory or path (lateral and longitudinal) that has been received from the behavior selector of the planning component(s) as closely as possible and within the capabilities of the vehicle.

The obstacle avoidance component(s) may aid the vehicle in avoiding collisions with objects (e.g., moving and stationary objects). In some examples, the obstacle avoidance component(s) may be used independently of components, features, and/or functionality of the vehicle that is required to obey traffic rules and drive courteously. In such examples, the obstacle avoidance component(s) may ignore traffic laws, rules of the road, and courteous driving norms in order to ensure that collisions do not occur between the vehicle and any objects. As such, the obstacle avoidance layer may be a separate layer from the rules of the road layer, and the obstacle avoidance layer may ensure that the vehicle is only performing safe actions from an obstacle avoidance standpoint. The rules of the road layer, on the other hand, may ensure that vehicle obeys traffic laws and conventions, and observes lawful and conventional right of way.

In some examples, the process 100 may continue to repeat using new sensor data 106 and generated using the sensor(s) 116 in order to continue determining updated information associated with the environment surrounding the machine. For instance, if the sensor data 106 is associated with a frame rate, then the process 100 may repeat based on the frame rate. For a first example, if the frame rate associated with the sensor data 106 (and/or other sensor data, perception data, etc.) is 30 frames per second, then the process 100 may repeat 30 times a second (e.g., with each frame). For a second example, if the frame rate associated with first sensor data 106 (and/or the other sensor data, the perception data, etc.) is again 30 frames per second, then the process 100 may repeat 15 time a second (e.g., with every other frame). In some examples, an instance of time as used herein may correspond to one or more frames in the frame rate. For instance, an instance of time may correspond to one frame of sensor data, two frames of sensor data, three frames of sensor data, etc. Additionally, a period of time as used herein may correspond to one or more of the instances of time. For instance, the period of time may correspond to one instance of time, two instances of time, three instances of time, etc.

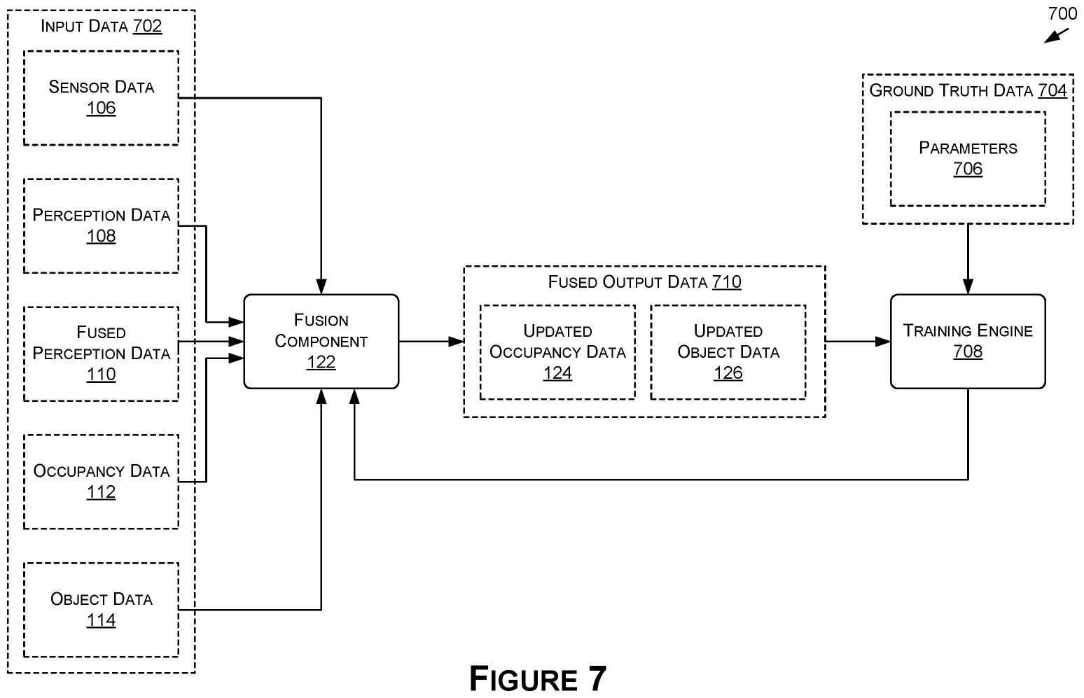

Now referring to FIG. 7, FIG. 7 is a data flow diagram illustrating an example process 700 for training the fusion component 122, in accordance with some embodiments of the present disclosure. As described above, the fusion component 122 may use one or more classical methods (e.g., algorithmic processes) and/or one or more learned models (e.g., machine learning, deep neural network, etc.) to generate the updated occupancy data 124 and/or the updated object data 126. As such, the process 700 may be used for training the one or more learned models of the fusion component 122.

As shown, the fusion component 122 may be trained using various input data 702 (e.g., training input data), which may include one or more of the sensor data 106, the perception data 108, the fused perception data 110, the occupancy data 112, and/or the object data 114. In some examples, the input data 702 may include one or more actual (e.g., previously generated and/or stored) versions of the sensor data 106, the perception data 108, the fused perception data 110, the occupancy data 112, and/or the object data 114. Additionally, or alternatively, the input data 702 may be based on the actual versions of the sensor data 106, the perception data 108, the fused perception data 110, the occupancy data 112, and/or the object data 114. For instance, the input data 702 may include one or more modified versions of the sensor data 106, the perception data 108, the fused perception data 110, the occupancy data 112, and/or the object data 114.

The fusion component 122 may be trained using the input data 702 as well as corresponding ground truth data 704. The ground truth data 704 may include annotations, labels, masks, and/or the like. For example, in some embodiments, the ground truth data 704 may indicate actual values of parameters 706 associated with the object(s) within the environment. For instance, and for an object, the parameters 706 may include, but are not limited to, a x-coordinate location, a y-coordinate location, a z-coordinate location, a height, a width, a length, a velocity in the x-direction, a velocity in the y-direction, an orientation, a classification, point locations, bounding shape locations, bounding shape sizes, object classifications, and/or any other parameter. The ground truth data 704 may be generated within a drawing program (e.g., an annotation program), a computer aided design (CAD) program, a labeling program, another type of program suitable for generating the ground truth data 704, and/or may be hand drawn, in some examples. In any example, the ground truth data 704 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 708 may use one or more loss functions that measure loss (e.g., error) in fused output data 710 generated by the fusion component 122 as compared to the ground truth data 704. The fused output data 710 may include the updated occupancy data 124 and/or the updated object data 126. In some examples, any type of loss function may be used, such as cross entropy loss, mean squared error, mean absolute error, mean bias error, and/or other loss function types. In some examples, different outputs may have different loss functions. For example, the x-coordinate location may include a first loss, the y-coordinate location may include a second loss, the z-coordinate location may include a third loss, and/or so forth. In such examples, the loss functions may be combined to form a total loss, and the total loss may be used to train (e.g., update the parameters of) the fusion component 122. In any example, backward pass computations may be performed to recursively compute gradients of the loss function(s) with respect to training parameters. In some examples, weight and biases of the fusion component 122 may be used to compute these gradients.

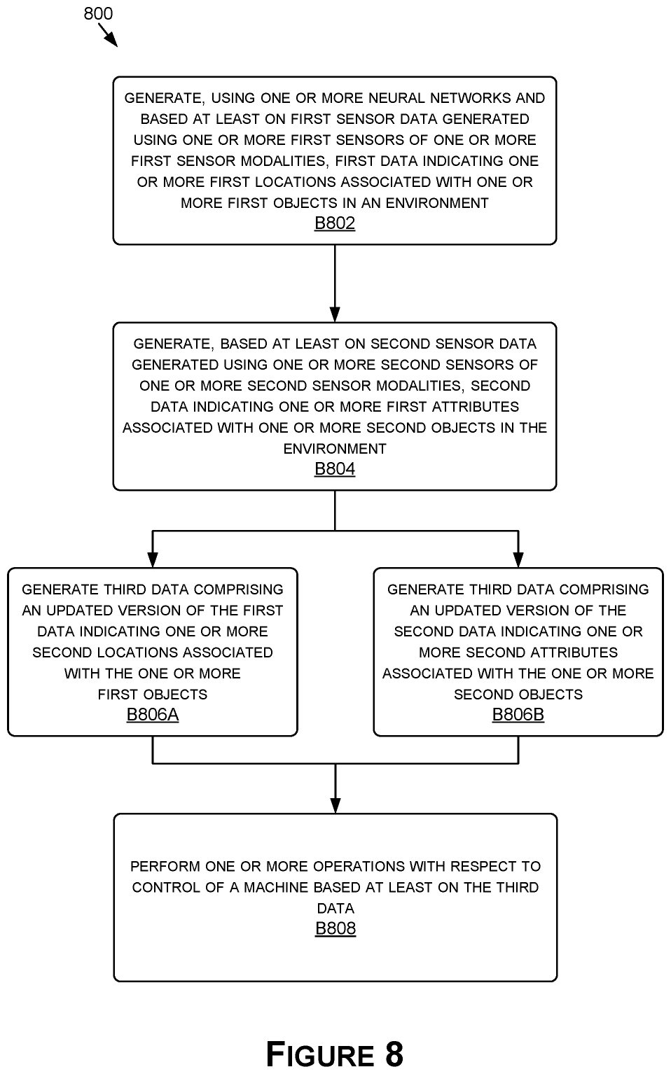

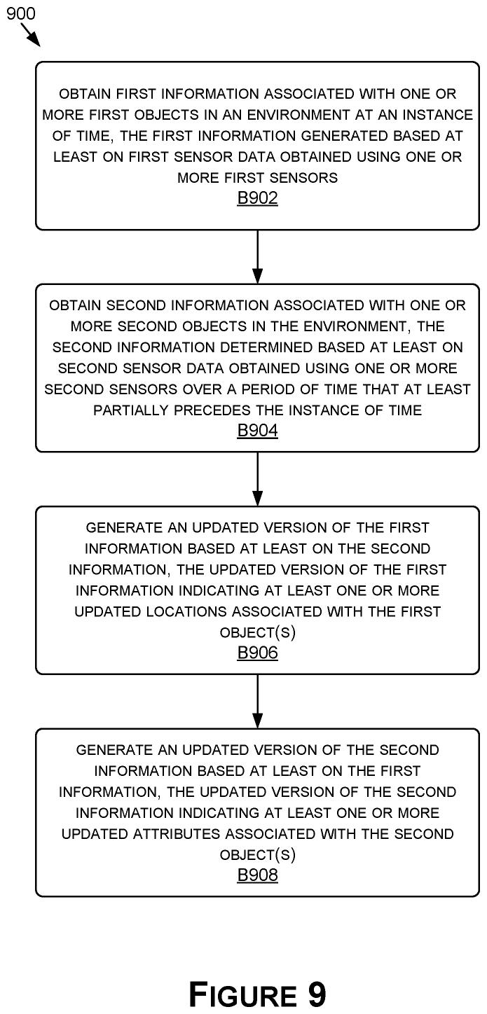

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 800 and 900 are described, by way of example, with respect to FIG. 1. However, these methods may additionally or alternatively be executed by any one system, or any combination of systems, including, but not limited to, those described herein.

With reference first to FIG. 8, FIG. 8 is a flow diagram illustrating an example method 800 for fusing disparate information generated using both learned and classic sensor processing techniques, in accordance with some embodiments of the present disclosure. The method 800, at block B802, may include generating, using one or more neural networks and based at least on first sensor data generated using one or more first sensors of one or more first sensor modalities, first data indicating one or more first locations associated with one or more first objects in an environment. For instance, the machine-learned model(s) 102 may generate, using the neural network(s) and based at least on the first sensor data (e.g., sensor data 106) generated using the first sensor(s) (e.g., sensor(s) 116) of the machine, the first data (e.g., occupancy data 112) indicating the first location(s) associated with the first object(s) in the environment.

At block B804, the method 800 may include generating, based at least on second sensor data generated using one or more second sensors of one or more second sensor modalities, second data indicating one or more first attributes associated with one or more second objects in the environment. For instance, the processing component(s) 104 may generate, based at least on the second sensor data (e.g., sensor data 106) generated using the second sensor(s) (e.g., sensor(s) 116) of the machine, the second data (e.g., object data 114) indicating the first attribute(s) associated with the second object(s) in the environment. In some examples, the second sensor modality(ies) may be the same as, or different from, the first sensor modality(ies), and/or the first sensor(s) may be the same as, or different from, the second sensor(s).

At block B806A, the method 800 may include generating third data comprising an updated version of the first data indicating one or more second locations associated with the one or more first objects. For instance, the fusion component 122 may generate the third data (e.g., updated occupancy data 124) comprising the updated version of the first data (e.g., occupancy data 112) indicating the second location(s) associated with the first object(s).

Alternatively, or additionally, at block B806B, the method 800 may include generating third data comprising an updated version of the second data indicating one or more second attributes associated with the one or more second objects. For instance, the fusion component 122 may generate the third data (e.g., updated object data 126) comprising the updated version of the second data (e.g., object data 114) indicating the second attribute(s) associated with the second object(s).

At block B808, the method 800 may include performing one or more operations with respect to control of a machine based at least on the third data. For instance, the downstream component(s) 128 may include one or more components of the machine, such as a planning component for planning a trajectory for the machine, a localization component for determining a location of the machine with respect to the environment it is operating in, a prediction component for predicting behavior of objects in the environment, etc. The downstream component(s) 128 may cause the machine to perform the operation(s) based at least on the third data. For instance, the downstream component(s) 128 may cause the machine to traverse the environment along a specific trajectory.

Now referring to FIG. 9, FIG. 9 is a flow diagram illustrating another example method 900 for fusing information obtained using different processing techniques, in accordance with some embodiments of the present disclosure. The method 900, at block B902, may include obtaining first information associated with one or more first objects in an environment at an instance of time, the first information generated based at least on first sensor data obtained using one or more first sensors. For instance, the fusion component 122 may obtain the first information (e.g., occupancy data 112) associated with the first object(s) in the environment at the instance of time. Additionally, the first information (e.g., the occupancy data 112) may be generated based at least on the first sensor data (e.g., sensor data 106) obtained from the first sensor(s) (e.g., sensor(s) 116).

At block B904, the method 900 may include obtaining second information associated with one or more second objects in the environment, the second information determined based at least on second sensor data obtained using one or more second sensors over a period of time that at least partially precedes the instance of time. For instance, the fusion component 122 may obtain the second information (e.g., object data 114) associated with the second object(s) in the environment. Additionally, the second information (e.g., object data 114) may be determined based at least on the second sensor data (e.g., sensor data 106) obtained from the second sensor(s) (e.g., sensor(s) 116) over the period of time.

At block B906, the method 900 may include generating an updated version of the first information based at least on the second information, the updated version of the first information indicating at least one or more updated locations associated with the one or more first objects. For instance, the fusion component 122 may generate the updated version (e.g., updated occupancy data 124) of the first information (e.g., occupancy data 112) based at least on the second information (e.g., object data 114). Additionally, the updated version (e.g., updated occupancy data 124) of the first information (e.g., occupancy data 112) may indicate at least the updated location(s) associated with the first object(s).

At block B908, the method 900 may include generating an updated version of the second information based at least on the first information, the updated version of the second information indicating at least one or more updated attributes associated with the one or more second objects. For instance, the fusion component 122 may generate the updated version (e.g., updated object data 126) of the second information (e.g., object data 114) based at least on the first information (e.g., occupancy data 112). Additionally, the updated version (e.g., updated object data 126) of the second information (e.g., object data 114) may indicate at least the updated attribute(s) associated with the second object(s).

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: generating, using one or more neural networks and based at least on first sensor data generated using one or more first sensors of one or more first sensor modalities, first data indicating one or more first locations associated with one or more first objects in an environment; generating, based at least on second sensor data generated using one or more second sensors of one or more second sensor modalities different from the one or more first sensor modalities, second data indicating one or more first attributes associated with one or more second objects in the environment; generating, based at least on at least a first portion of the first data and at least a second portion of the second data, third data comprising at least one of: an updated version of the first data indicating one or more second locations associated with the one or more first objects; or an updated version of the second data indicating one or more second attributes associated with the one or more second objects; and performing one or more operations with respect to control of a machine based at least on the third data.

B. The method as recited in paragraph A, wherein: the first data is instantaneous data indicating the one or more first locations associated with the one or more first objects in the environment surrounding the machine at an instance of time, and the second data is temporal data and the one or more first attributes are tracked over a period of time that at least partially precedes the instance of time.

C. The method as recited in any one of paragraphs A-B, wherein: the first data further indicates one or more occluded portions of the environment, and the updated version of the first data further indicates whether the one or more occluded portions of the environment are occupied by at least one of the one or more first objects or at least one of the one or more second objects.

D. The method as recited in any one of paragraphs A-C, wherein: an attribute of the one or more first attributes includes at least one of: a first bounding shape associated with an object of the one or more second objects, a first location associated with the object, a first pose associated with the object, a first trajectory associated with the object, or a first classification associated with the object, and an attribute of the one or more second attributes includes at least one of: a second bounding shape associated with the object, a second location associated with the object, a second pose associated with the object, a second trajectory associated with the object, or a second classification associated with the object.

E. The method as recited in any one of paragraphs A-D, wherein the first data is a dense occupancy representation of the environment from a top-down perspective, the dense occupancy representation including one or more points representing one or more samples obtained using the one or more first sensors at an instance of time, wherein one or more first points of the one or more points correspond to the one or more first locations associated with the one or more first objects and one or more second points of the one or more points correspond to one or more unoccupied locations in the environment at the instance of time.

F. The method as recited in any one of paragraphs A-E, wherein one or more values of the one or more points correspond to at least one of a height or a confidence associated with the one or more samples.

G. The method as recited in any one of paragraphs A-F, further comprising: determining that a first object of the one or more first objects corresponds to a second object of the one or more second objects, wherein the generating the third data is further based at least on the first object corresponding to the second object.

H. The method as recited in any one of paragraphs A-G, further comprising: generating fourth data indicating one or more prior locations associated with the one or more first objects in the environment, the fourth data including one or more points representing one or more prior samples obtained using the one or more first sensors over a period of time and refined based at least on the one or more first attributes, wherein the generating the third data is further based at least on the fourth data.

I. The method as recited in any one of paragraphs A-H, wherein a first point of the one or more points included in the fourth data is indicative of a velocity associated with an object of the one or more first objects.

J. The method as recited in any one of paragraphs A-I, further comprising causing the machine to perform one or more operations based at least on at least one of the updated version of the first data or the updated version of the second data.

K. A system comprising: one or more processors to: obtain first information indicating one or more locations associated with one or more first objects in an environment at an instance of time, the first information generated using one or more neural networks and based at least on first sensor data obtained using one or more first sensors of a machine; obtain second information indicating one or more attributes associated with one or more second objects in the environment, the second information determined based at least on second sensor data obtained using one or more second sensors of the machine over a period of time that at least partially precedes the instance of time; and generate at least one of: an updated version of the first information based at least on the second information, the updated version of the first information indicating at least one or more updated locations associated with the one or more first objects; or an updated version of the second information based at least on the first information, the updated version of the second information indicating at least one or more updated attributes associated with the one or more second objects.

L. The system as recited in paragraph K, wherein the first information is associated with the instance of time and the updated version of the first information is temporal information associated with the instance of time and at least a portion of the period of time.

M. The system as recited in any one of paragraphs K-L, wherein: the first information indicates one or more occluded portions of the environment at the instance of time, and the updated version of the first information further indicates whether the one or more occluded portions of the environment are occupied by at least one of the one or more first objects or at least one of the one or more second objects.

N. The system as recited in any one of paragraphs K-M, wherein: an attribute of the one or more updated attributes includes at least one of: a bounding shape associated with an object of the one or more second objects, a location associated with the object, a pose associated with the object, a trajectory associated with the object, or a classification associated with the object.

O. The system as recited in any one of paragraphs K-N, wherein: the first information is a dense occupancy representation of the environment from a top-down perspective, the dense occupancy representation including one or more points representing one or more samples obtained using the one or more first sensors at the instance of time, one or more first points of the one or more points correspond to the one or more locations associated with the one or more first objects, one or more second points of the one or more points correspond to one or more unoccupied locations in the environment at the instance of time, and one or more values of the one or more points correspond to at least one of a height or a confidence associated with the one or more samples.

P. The system as recited in any one of paragraphs K-O, the one or more processors are further to generate third information indicating one or more prior locations associated with the one or more first objects in the environment, the third information including one or more points representing one or more prior samples obtained using the one or more first sensors over the period of time and refined based at least on the second information, wherein the generation of the at least one of the updated version of the first information or the updated version of the second information is further based at least on the third information.

Q. The system as recited in any one of paragraphs K-P, wherein the one or more first sensors include one or more of: an image sensor; a radar sensor; an ultrasonic sensor; or a LiDAR sensor.

R. The system as recited in any one of paragraphs K-Q, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more large language models (LLMs); a system for generating synthetic data; a system incorporating one or more virtual machines (VMs); a system implemented at least partially in a data center; or a system implemented at least partially using cloud computing resources.

S. A processor comprising: one or more processing units to generate one or more updated versions associated with at least one of an occupancy representation corresponding to an environment or one or more attributes associated with one or more objects detected in the environment, wherein the occupancy representation is generated using one or more neural networks and based at least on first sensor data obtained using one or more first sensors of one or more first sensor modalities and the one or more attributes are determined using one or more algorithmic processes and based at least on second sensor data obtained using one or more second sensors of one or more second sensor modalities different from the one or more first sensor modalities.

T. The processor as recited in paragraph S, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more large language models (LLMs); a system for generating synthetic data; a system incorporating one or more virtual machines (VMs); a system implemented at least partially in a data center; or a system implemented at least partially using cloud computing resources.

What is claimed is:

1. A method comprising:
generating, using one or more neural networks and based at least on first sensor data generated using one or more first sensors of one or more first sensor modalities, first data indicating one or more first locations associated with one or more first objects in an environment;
generating, based at least on second sensor data generated using one or more second sensors of one or more second sensor modalities different from the one or more first sensor modalities, second data indicating one or more first attributes associated with one or more second objects in the environment;
generating, based at least on at least a first portion of the first data and at least a second portion of the second data, third data comprising at least one of:
an updated version of the first data indicating one or more second locations associated with the one or more first objects; or
an updated version of the second data indicating one or more second attributes associated with the one or more second objects; and
performing one or more operations with respect to control of a machine based at least on the third data.

2. The method of claim 1, wherein:
the first data is instantaneous data indicating the one or more first locations associated with the one or more first objects in the environment surrounding the machine at an instance of time, and
the second data is temporal data and the one or more first attributes are tracked over a period of time that at least partially precedes the instance of time.

3. The method of claim 1, wherein:
the first data further indicates one or more occluded portions of the environment, and
the updated version of the first data further indicates whether the one or more occluded portions of the environment are occupied by at least one of the one or more first objects or at least one of the one or more second objects.

4. The method of claim 1, wherein:
an attribute of the one or more first attributes includes at least one of:
a first bounding shape associated with an object of the one or more second objects,
a first location associated with the object,
a first pose associated with the object,
a first trajectory associated with the object, or
a first classification associated with the object, and
an attribute of the one or more second attributes includes at least one of:
a second bounding shape associated with the object,
a second location associated with the object,
a second pose associated with the object,
a second trajectory associated with the object, or
a second classification associated with the object.

5. The method of claim 1, wherein the first data is a dense occupancy representation of the environment from a top-down perspective, the dense occupancy representation including one or more points representing one or more samples obtained using the one or more first sensors at an instance of time, wherein one or more first points of the one or more points correspond to the one or more first locations associated with the one or more first objects and one or more second points of the one or more points correspond to one or more unoccupied locations in the environment at the instance of time.

6. The method of claim 5, wherein one or more values of the one or more points correspond to at least one of a height or a confidence associated with the one or more samples.

7. The method of claim 1, further comprising:
determining that a first object of the one or more first objects corresponds to a second object of the one or more second objects,
wherein the generating the third data is further based at least on the first object corresponding to the second object.

8. The method of claim 1, further comprising:
generating fourth data indicating one or more prior locations associated with the one or more first objects in the environment, the fourth data including one or more points representing one or more prior samples obtained using the one or more first sensors over a period of time and refined based at least on the one or more first attributes,
wherein the generating the third data is further based at least on the fourth data.

9. The method of claim 8, wherein a first point of the one or more points included in the fourth data is indicative of a velocity associated with an object of the one or more first objects.

10. The method of claim 1, further comprising causing the machine to perform one or more operations based at least on at least one of the updated version of the first data or the updated version of the second data.

11. A system comprising:
one or more processors to:
obtain first information indicating one or more locations associated with one or more first objects in an environment at an instance of time, the first information generated using one or more neural networks and based at least on first sensor data obtained using one or more first sensors of a machine;
obtain second information indicating one or more attributes associated with one or more second objects in the environment, the second information determined based at least on second sensor data obtained using one or more second sensors of the machine over a period of time that at least partially precedes the instance of time; and
generate at least one of:
an updated version of the first information based at least on the second information, the updated version of the first information indicating at least one or more updated locations associated with the one or more first objects; or
an updated version of the second information based at least on the first information, the updated version of the second information indicating at least one or more updated attributes associated with the one or more second objects.

12. The system of claim 11, wherein the first information is associated with the instance of time and the updated version of the first information is temporal information associated with the instance of time and at least a portion of the period of time.

13. The system of claim 11, wherein:
the first information indicates one or more occluded portions of the environment at the instance of time, and
the updated version of the first information further indicates whether the one or more occluded portions of the environment are occupied by at least one of the one or more first objects or at least one of the one or more second objects.

14. The system of claim 11, wherein:
an attribute of the one or more updated attributes includes at least one of:
a bounding shape associated with an object of the one or more second objects,
a location associated with the object,
a pose associated with the object,
a trajectory associated with the object, or
a classification associated with the object.

15. The system of claim 11, wherein:
the first information is a dense occupancy representation of the environment from a top-down perspective, the dense occupancy representation including one or more points representing one or more samples obtained using the one or more first sensors at the instance of time,
one or more first points of the one or more points correspond to the one or more locations associated with the one or more first objects,
one or more second points of the one or more points correspond to one or more unoccupied locations in the environment at the instance of time, and
one or more values of the one or more points correspond to at least one of a height or a confidence associated with the one or more samples.

16. The system of claim 11, the one or more processors are further to generate third information indicating one or more prior locations associated with the one or more first objects in the environment, the third information including one or more points representing one or more prior samples obtained using the one or more first sensors over the period of time and refined based at least on the second information, wherein the generation of the at least one of the updated version of the first information or the updated version of the second information is further based at least on the third information.

17. The system of claim 11, wherein the one or more first sensors include one or more of:
an image sensor;
a radar sensor;
an ultrasonic sensor; or
a LiDAR sensor.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. A processor comprising:
one or more processing units to generate one or more updated versions associated with at least one of an occupancy representation corresponding to an environment or one or more attributes associated with one or more objects detected in the environment, wherein the occupancy representation is generated using one or more neural networks and based at least on first sensor data obtained using one or more first sensors of one or more first sensor modalities and the one or more attributes are determined using one or more algorithmic processes and based at least on second sensor data obtained using one or more second sensors of one or more second sensor modalities different from the one or more first sensor modalities.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
